(19) United States
(12) Patent Application Publication
(10) Pub. No.: US 2004/0117285 A1
(43) Pub. Date: Jun. 17, 2004

(54) Method and system for providing timely accurate and complete portfolio valuations

(76) Inventor: Daniel Friedrich Kohler, Summit, NJ (US)

Correspondence Address: Richard C Woodbridge, Synnestvedt Lechner & Woodbridge, PO Box 592, Princeton, NJ, 08542-0592, US

(21) Appl. No.: 10/474,889

(22) PCT Filed: Apr. 12, 2002
(86) PCT No.: PCT/US02/11516

(51) Int. Cl. G06F 17/60

(52) U.S. Cl. 705/36

(57) ABSTRACT

Serious asset management depends on financial portfolios being valued accurately in a timely and complete manner. Custom, and in some jurisdiction, rules and regulations demand that they be “marked to market”, i.e. that their valuation as closely as possible reflect the market value of the financial instruments that make up a portfolio. A structured database of financial instruments and system and method for updating the prices of these instruments (the DPSM or Deductive Pricing System and Method) permits the use of information contained in the structure of financial instruments to complement the available market information and to deduce prices for virtually all instruments in a portfolio, even if they are only rarely traded and market prices are not available at most times.

### CROSS REFERENCE TO RELATED APPLICATIONS

This application claims the priority of provisional U.S. application serial No. 60/283,664, filed on Apr. 13, 2001 and entitled “Method and System for Providing Timely Accurate and Complete Portfolio Valuations” by Daniel Friedrich Kohler, the entire contents and substance of which are hereby incorporated in total by reference.

### BACKGROUND OF THE INVENTION

1. Field of the Invention

The present invention relates to a method and a system for pricing financial instruments in a manner as to allow timely accurate and complete valuations of portfolios.

2. Description of Related Art

Instruments traded in financial markets have evolved significantly from the stocks and bonds that used to make up investor's portfolios. Financial innovators have devised ever more complicated derivative instruments and these “derivatives” are finding their way into the portfolios of private and institutional investors. More recently, so-called structured products, i.e. combinations of derivative instruments; offering specific advantages (e.g. a guaranteed return, albeit at a price) have become popular. In contrast to the underlying stocks and bonds most of these instruments and products are not listed on a regular exchange, are traded only infrequently, and have pricing and risk properties that re not obvious to most investors. Nevertheless, their number is growing, and they certainly outnumber the traditional exchange traded stocks and bonds many times over.

Serious portfolio management demands that an accurate market price, or at least a proxy for a market price, be available at all time. Unless a portfolio is valued accurately and completely, one cannot expect to know the implied risks of the current positions, and to be able to hedge these risks, if appropriate. Without timely, accurate and complete information about his portfolio, the portfolio manager is flying blind into the market uncertainty.

Not only portfolio managers, but also investors generally need to be informed about the fair value of portfolios. A number of spectacular failures where financial instruments in company portfolios were intentionally or unintentionally mispriced have clearly demonstrated the need for timely, accurate and complete pricing of financial instruments based on an accepted methodology. Furthermore, the SEC requires of mutual funds and other vehicles of collective investment that they value those instruments in their portfolios that are not traded regularly by the fair value principle.

There are established methods for estimating the fair value of financial instruments. The fair value yield of bonds can be valued based on the corresponding risk-free interest rate plus a risk spread that depends on the rating of the bond as well as on the specific characteristics of the issuer and of the issue. Black and Scholes have demonstrated a method for establishing the fair value of options. What is common to all these methods is that they involve an unknown parameter: the issuer or bond-specific risk spread in the case fixed income instruments and the expected volatility of the price of the underlying instrument between now and the time of expiration for an option. Before any method can be applied, a value for these parameters must be determined.

Current methods are based on the proxy principle: A proxy is used to obtain a more or less accurate estimate for the unknown parameters. For bonds it is usually assumed, that the issue to be valued has a fixed spread over treasuries (i.e. risk-free fixed income instruments) as it was established when the bond was initially issued. For options the past, historical volatility is taken as a proxy for the expected future volatility. Both assumptions are hardly realistic in rapidly changing market environments.

This is an important characteristic of virtually all derived instruments: their risk characteristics change not only with changes in the price of the instrument or of the underlying instrument, but also over time. Hence they need to be valued frequently, i.e. almost certainly more often than they are being traded.

The quickening pace at which markets move these days has exacerbated the difficulties of valuing financial instruments in a timely accurate and complete manner. Continuous news feeds, over the Internet as well as over traditional channels, have replaced the morning papers as a source of information about financial markets. By way of “on-line accounts” investor reactions to the continuously arriving information can be translated into trades almost instantly, and “straight through processing” assures that these “buy” or “sell” orders arrive in the markets in a snap. The markets themselves are more and more automated; computer networks and trade matching systems replace the trading pits. Adjustments in the financial markets that used to take a few days, or at least over night, are not taking place in minutes.

The only part of the system that has not kept up with this acceleration is the valuation of portfolios and the tasks dependent on it (i.e. exposure measurement, risk control etc.). It is still customary to value all financial instruments, even those traded only infrequently, at the “last paid price”, which often means yesterday's closing price. If the instrument is not traded very often, this price may well be a few days, if not weeks old. Worse still, the instrument may not even be included in the database for which a standard price provider such as Bloomberg, Reuters, Bridge etc. provides information. In this case the asset manager is stuck with what he or she considers the best guess, or the Asset Manager is forced to calculate and re-calculate prices and risk parameters on an ad-hoc basis.

### SUMMARY OF THE INVENTION

Briefly described, the present invention provides a method and a system for valuing all financial instruments held in a portfolio in a timely accurate and complete manner. At the core is a structured database of financial instruments that accurately reflects the different links and dependencies among various instruments. The information contained in the structure of an instrument is used to infer “fair values”, (i.e. price-proxies) in those instances when no satisfactory market price is available. A satisfactory market price is an observed price either from a recent trade, or from buy-sell prices posted by a bona-fide market maker.

What is considered “recent” varies by type of instrument. For equities that are traded on a public stock market, for example, “recent” would mean within the last 20 to 30 minutes. For fixed income instruments and other instruments traded less frequently, “recent” might be within the last hour or two.

The database is structured in a hierarchical manner. Depending on their structure, financial instruments are place in groups (“classes”) that share relevant characteristics. The lowest classes contain exchange rates, interest rates and exchange-traded securities, i.e. financial instruments for which valid market prices are almost always available. In the preferred embodiment, the present invention is contained in a method and system, the Deductive Pricing Method and System (DPMS), that calculates prices and risk parameters of each higher class of instruments referring only to information from instruments in lower classes, and ultimately from the lowest classes for which valid market data is almost always available. Contrary to current art, the unknown parameters are not based on historical data, but are also inferred from current market data, on those occasions when market prices are available.

Consider a fixed income instrument that is issued at a specific spread over treasuries. Typical for this type of instrument it is traded relatively frequently after issue, but as time goes on the market calms down and the issue is no longer traded regularly. However, investors holding this instrument in their portfolio need to continue valuing this instrument accurately, even if no market prices are available anymore.

The invention comprises a method and system whereby the yield to maturity of the instrument as established whenever the issue is traded is disaggregated into (i) a risk free yield (i.e. treasury yield), (ii) a rating specific risk spread and (iii) an instrument specific risk spread. The “rating specific” risk spread is the average risk spread of instruments the are rated as comparable by the different rating agencies (Moody's. S&P, Fitch etc.), while the “instrument-specific” risk spread is the extent to which the risk spread of the instrument in questions deviates from this average.

There is always an active market for treasuries, and the risk free interest rate can always be established. Furthermore, a number of rating agencies regularly publish normalized risk spreads for rated bonds. It is thus always possible to obtain a good estimate for the first two components that make up the yield of a bond, independently of whether the bond is traded or not. These two components usually make up over 90% of a specific Bond's yield. For the third component, the instrument specific risk spread, the DPMS uses the instrument specific spread as it was established the last time the issue was traded.

For options a similar method is used. The mathematical form of the function that establishes the fair value of an option has been developed by Black and Scholes, and it has only one parameter that cannot be observed directly: The expected volatility of the price of the underlying instrument (the “volatility”). Whenever the option is traded, however, we can obtain an estimated of the volatility that is implied by the market price paid. This is a significantly better estimate of the expected volatility than the “historical” volatility commonly used, for it reflects not only the historical record of past price movements but also the buyer's and seller's expectations about future price movements.

A particular class of derived instruments are composite instruments that consist of a fixed income instrument combined with an option. This class includes convertible bonds, preferred stock and structured notes and debentures. They are traded as one instrument, even though they can conceptually be viewed as two.

The DPMS disaggregates these instruments into their components and then values each component separately. A convertible bond is disaggregated into a bond and an option and each is valued separately by the corresponding method described above. The individual fair value estimates are then combined into a composite fair value estimate for the convertible bond.

Derived instruments, including composite instruments, are almost always traded much less frequently than the underlying instruments themselves. While a specific stock may be traded daily, a call or put option on that stock (the derived instrument) may be traded only a few time a month. The DPMS will use those instances when the derived instruments are traded to update the estimates of the unknown parameters and with these estimates will produce fair value estimates for the derived instruments based on the prices of the underlying instruments, including risk free interest rates and rating specific risk spreads, whenever the derived instruments themselves are not traded.

In this manner, the system will always give precedence to market information. Observed market data is used to infer estimates of non-observable parameters, i.e. the instrument specific spread for fixed income instruments and the volatility for options. In those instances when market prices for the derived instruments can be observed, the fair value estimates produced by the DPMS have to substantially coincide with these market prices. Accordingly, the fair value estimates produced by the DPMS will be at least as good as market prices, which currently rule portfolio valuation methods, and offer a significant improvement over these whenever market prices for the derived instrument are not available.

The invention may be more fully understood by reference to the following drawings.

### BRIEF DESCRIPTION OF THE DRAWINGS

FIG. 1 illustrates the different classes of instruments in the hierarchical order in which they are included in the structured central database.

FIG. 2 illustrates how complex instruments (i.e. instruments of classes higher than simple instruments) are disaggregated into embedded instruments in lower classes.

FIGS. 3A, 3B-1 and 3B-2 comprise a flow chart describing the preferred embodiment of the Deductive Pricing Method and System (DMPS) wherein FIG. 3A illustrates how the database is updated if a valid and recent market price observation is available and FIGS. 3B-1 and 3B-2 illustrate the method and system when the markets price is not valid or not recent, i.e. is “stale”.

### DETAILED DESCRIPTION OF THE PREFERRED EMBODIMENT

During the course of this description, similar numbers will be used to identify similar elements according to different views, which illustrate the invention.

### Structure of the Database

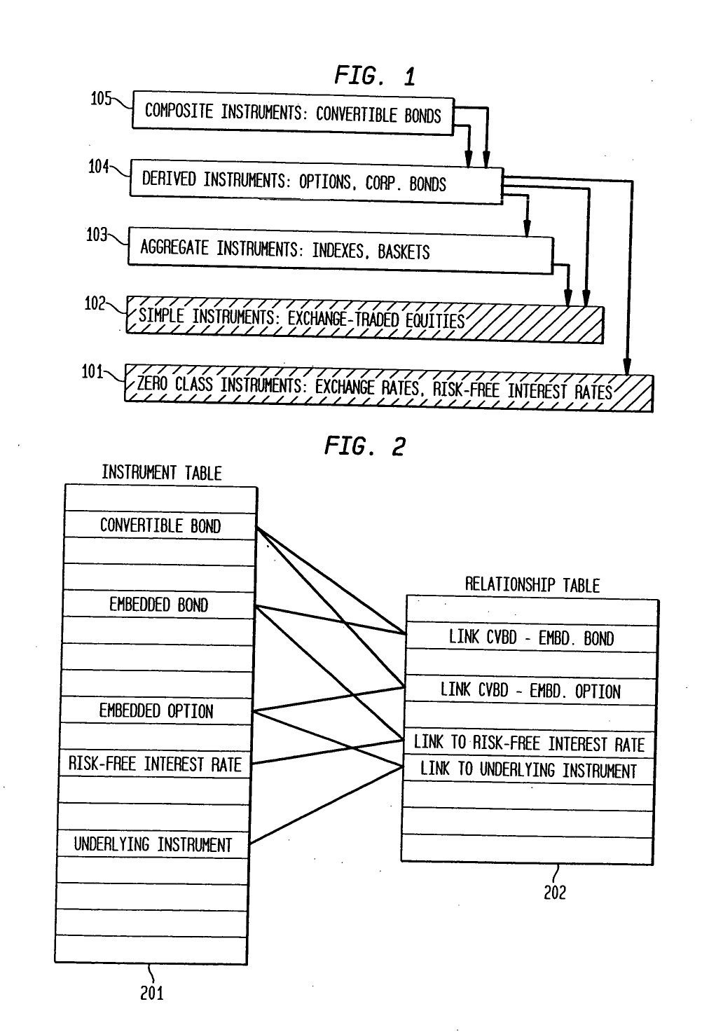

FIG. 1 illustrates the structured database of financial instruments that is at the core of the current invention. Financial instruments such as securities, options and other instruments are placed into groups (“classes”) depending on their characteristics. The categories reflect the way in which different instruments are dependent on each other. Also included in the database are financial data that have an influence on the valuation of financial instruments, but that are not financial instruments themselves. These data include exchange rates for foreign currencies, government bond yields as proxies for risk-free interest rates, etc. These financial data are identified as Zero Class Instruments 101.

Simple (financial) Instruments 102 are instruments that are not dependent on other instruments (e.g. exchange traded equities). The market, usually a regulated exchange, determines their prices and there is no legitimate alternative to valuing them other than by market prices.

Fortunately, prices of simple instruments, like those of Zero Class Instruments 101, are almost always available. There may be special circumstances when individual stocks are suspended from trade on some exchanges. In these situations, no current price exists, and there is no legitimate way of inferring a proxy for a market price either. Such situations are rare exceptions, however. Usually market prices of simple instruments exist and are made available by the exchanges where the instruments are traded.

The Zero Class Instruments 101 and Simple Instruments 102 are shaded in FIG. 1 to indicate that for these instruments there exist no alternative to the market price. Availability of market prices for these two classes is a necessary, if not sufficient, condition for the DPSM to be applied.

Aggregate Instruments 103 are instruments whose price is a function of the prices of Simple and Zero Class Instruments and all parameters are known a priori. The most common types of aggregate instruments are indexes and baskets, where the price of the instrument is a linear combination of the prices of Simple Instruments 102. The Dow Jones Industrials Index, for example, is a weighted average of the prices of 30 stocks traded on the New York Stock Exchange, with the individual weights known. Other examples are American Depository Receipts and similar certificates whose price is a function of the price of a simple instrument, traded on a non-US exchange, multiplied by the appropriate exchange rate.

The parameters necessary for calculating the price of the Aggregate Instruments 103 from the prices of the simple underlying instruments are stored in the Relationship Table (see FIG. 2). It follows that if the prices of the Simple 102 and Zero Class 101 Instruments are known, the price of the Aggregate Instruments 103 can be calculated as well. Thus, even if the Aggregate Instruments 103 are not traded, or a market price is not available for some other reason, this invention will produce an accurate proxy (the “fair value”) for the price at all times.

Derived Instruments 104 include not only equity options and derivatives, but also corporate bonds and other debt instruments issued by private borrowers. What these instruments have in common is that their value can be inferred from the prices of underlying instruments that are in classes lower than “Derived Instruments”. Furthermore, the form of the function mapping the prices of the underlying instruments into the price of the derived instrument is known, although not all parameters are known. In the case of options the unknown parameters is the volatility (σ) that market participants expect for the underlying security, in the case of corporate bonds it is the risk premium (δ), i.e. the extent to which the yield on the specific corporate bond will be above the yield of a corresponding risk-free (government) bond.

Values for these parameters, though unknown, can be estimated every time a valid observation of the market price becomes available. In other words, whenever a specific option is traded, we can observe a market price from which we can infer the corresponding value of σ, called the “implied volatility”. This estimate of σ can then be used to infer valuations for the option from this point on forward, even if no market transactions take place. It will be updated whenever a new market price results in a new implied volatility being estimated. To distinguish this valuation from market price valuation, it has become customary to refer to it as the “fair value”.

Analogously, the value of δ can be estimated, whenever a market transaction involving the corporate bond is observed. This can then be used to value the bonds at its' “fair value” from that point on forwards, varying the bond price in accordance with changes in the risk-free interest rates, until a new market observation on the corporate bond causes us to update the value of δ.

In the preferred embodiment of this invention, it is possible to manually override the markets estimate of σ and δ, or to limit their deviations from previous values, in order to prevent outliers in the observed market prices from taking on an undue influence on future prices, and to initiate the process when no market observations are available at first.

Finally, the highest class of instruments are Composite Instruments 105. As the name implies, these are composites of instruments from lower classes. For example, a convertible bond can be represented as a composite of a straight corporate bond and an equity option. A structured note typically exists of a money market instrument and a short position in an equity-, exchange rate- or index option.

In the database, on which the preferred embodiment of this invention is based, these embedded instruments are also explicitly included as instruments in their own right. Since they are instruments of lower classes, they can be valued, even if no separate (market) prices can be observed for them. And since these components can be valued, so can the composite instrument.

### Relationships among Classes of Instruments

How this valuation is accomplished is most readily shown with an example. FIG. 2 illustrates the database represented by its two main tables, the Instruments Table 201 and the Relationship Table 202. The Instruments Table 201 contains one row for each instrument, containing all the instrument specific information. The Relationship Table 202 contains one or several rows for each instruments that is related to one or several other instruments of a lower class, regardless of whether these instruments are exchange-traded or not.

For any instrument, other than Simple Instruments 102 or Zero Class Instruments 101, several entries in the Instrument Table will be relevant. Consider a convertible bond, a Composite Instrument 105. There will be a row for the convertible bond in the Instrument Table 201, and there will be at least two associated rows in the Relationship Table 202: one relating the convertible bond to the row of the embedded bond and one to relate the convertible bond to the embedded option. The embedded bond in turn is related to the corresponding risk-free interest rate, a Zero Class Instrument 101, and the option is related to the underlying instrument (usually an equity, i.e. a Simple Instrument 102). If the underlying instrument itself was an Aggregate Instrument 103, as is not uncommon, then this underlying Aggregate Instrument 103 would itself be related to one or several Simple 102 or Zero Class 101 Instruments.

With estimates for the parameters σ and δ we can value the composite instrument as follows: from the risk-free interest rate and from δ we can infer the fair value of the embedded bond. From the price of the underlying and σ we can infer the fair value of the embedded option. The fair value of the convertible bond is the weighted sum of these two valuations, and it will change if either the interest rate of the price of the underlying instruments changes.

Note that it will not be possible to simultaneously infer both σ and δ from a single observation of the market price for the convertible bond; there are not enough degrees of freedom. It will thus be necessary to manually fix the value of one of the parameters, δ, by reference to similar bonds issued by the same issuer. In this case the fair value of the bond can be calculate without reference to the market price of the convertible bond, and the market value of the embedded option can be obtained by deducting the fair value of the embedded bond from the market price of the convertible bond. The parameter σ can then be estimated as described above.

### Deductive Pricing System and Method

FIGS. 3A, 3B-1 and 3B-2 are flow-chart representations of the steps of the Deductive Pricing System and Method (DPSM), the preferred embodiment of the current invention. The financial instruments contained in the Instrument Table 201 are sequentially considered for price updates. If a recent “Last Trade” market price 301 is available then it is used to update the valuation price 302 of the Instrument. The time of this update 303 is recorded and a flag 304 is set, identifying this price as a “market price”.

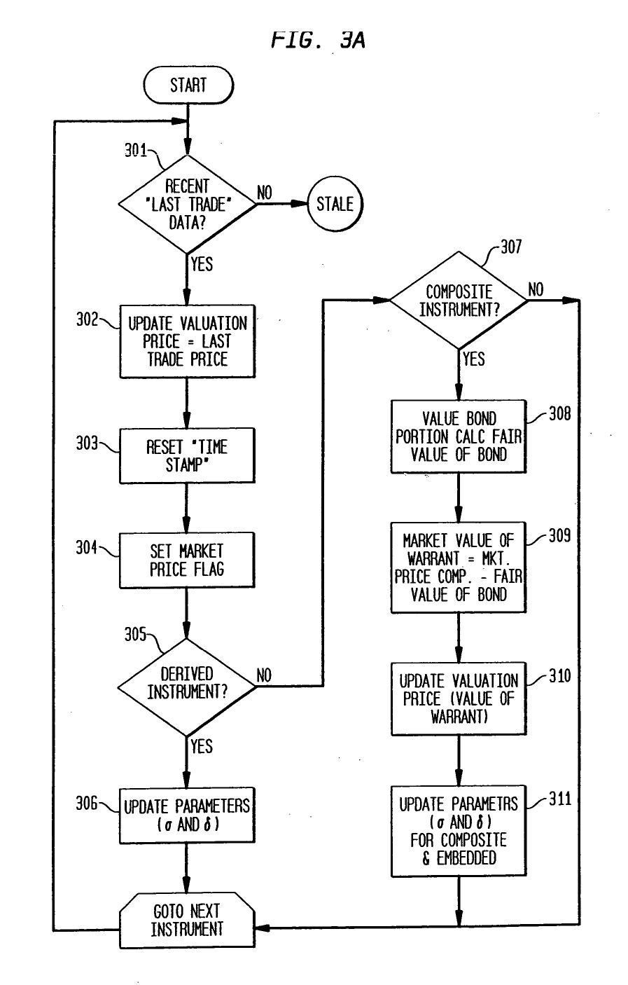

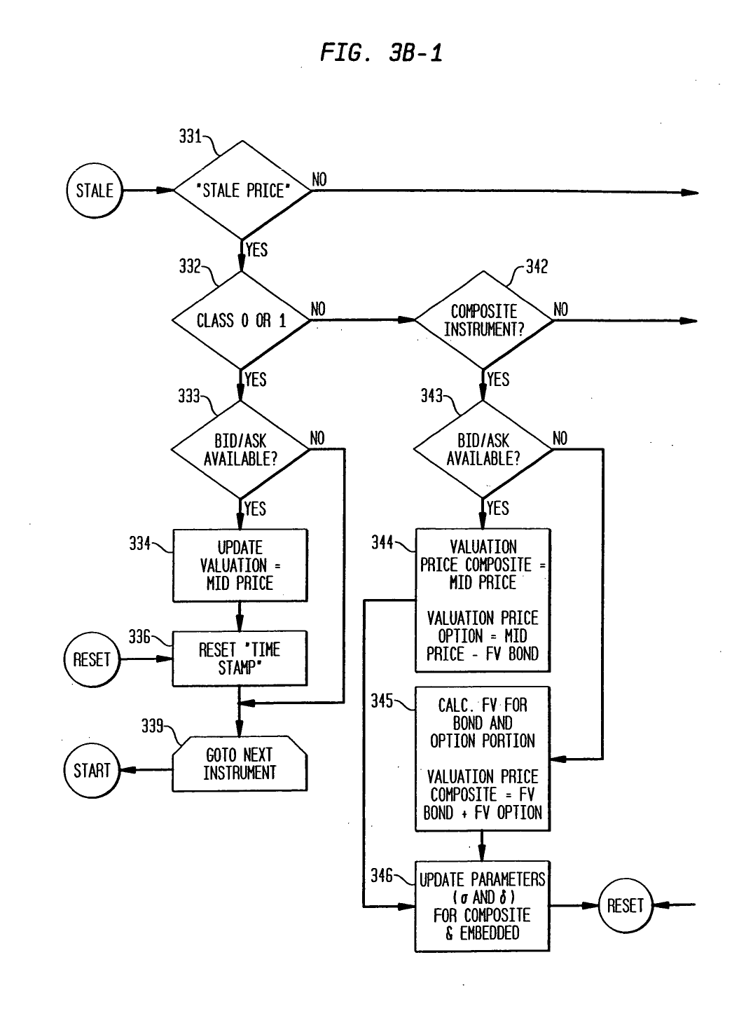

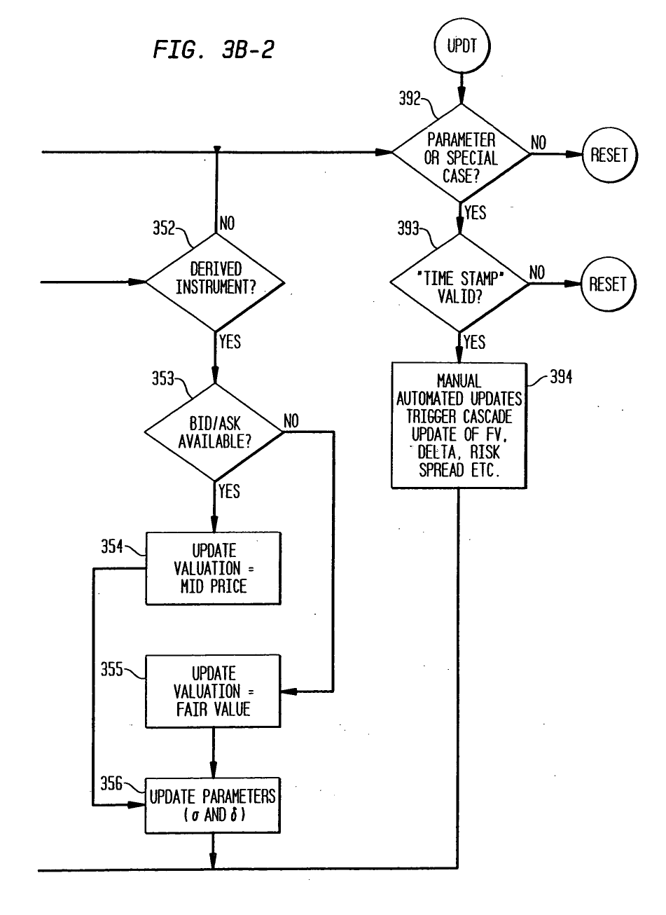

If, as shown in FIG. 3A, the current instrument is a Derived Instrument 104, 305, the parameters σ or δ are estimated and updated 306 and the system and method then proceeds to the next instruments. If it is not a Derived Instrument 104, the system and method tests whether it is a Composite Instrument 105, 307. If it is not a Composite Instrument 105, then it must be a Zero Class-, Simple- or Aggregate Instrument 101, 102, 103, in which case the system and method proceeds directly to the next instrument in the update queue.

If it is a Composite Instrument 105, however, the fair value of the bond portion has to be calculated first 308, whereupon the market value of the option portion (or “warrant”) can be inferred by subtracting the fair value of the bond from the market value of the Composite Instrument 105 as shown in step 309. This results in an estimate of the value of the option or warrant portion of the convertible bond which can now be updated 310. Based on these estimates, we can infer and update the parameter σ 311.

There are some convertible bonds that are trade “ex warrant”, i.e. the embedded bond is trade separately. In this case an independent observation of the value of the bond portion of the composite instrument can be obtained, whenever the “ex warrant” bond is traded. In this case the parameter δ can be updated as well.

If no current “Last Trade” price is available, i.e. the only available price is “stale”, the DPSM proceeds in the manner shown in FIGS. 3B-1 and 3B-2. If the current instrument is a Zero Class or Simple Instrument 101, 102, 332, and if “bid” and “ask” prices are posted by a bona-fide market maker 333, the mid-point between these two posted prices is used as a proxy for the market price 334, and after updating the time stamp 338 the DPSM proceeds to the next instrument in the update queue 339. If “bid” and “ask” prices are not available, nothing can be done, and the old “stale” last trade price is still the best price obtainable for the current instrument.

If the current instrument is not a Zero Class 101 or a Simple Instrument 102, the DPSM that tests whether it is a Composite Instrument 105, 342 or a Derived Instrument 104, 352. If it is neither, there is still the possibility of a manual price update steps 392-394, and resetting of the time stamp 338 prior to proceeding to the next instrument in the update queue 339. If no manual price update is undertaken, the DPSM proceeds to the next instrument directly.

If the current instrument is Composite Instrument 105, 342 and “bid” and “ask” prices posted by a bona-fide market maker are available 343, the Composite Instrument 105 is valued by the mid-price between the posted bid and ask prices 344. From that point on, the process proceeds exactly as in the case of a valid last trade price (see above steps 344 through 311). If no “bid” and “ask” prices are posted, the fair values of the embedded instruments are calculated and the fair value of the convertible bond is obtained as a weighted sum of the embedded components 345 before proceeding to the next instrument in the update queue.

If the current instrument is a Derived Instrument 104, 352 and “bid” and “ask” prices posted by a bona-fide market maker are available 353, then the mid-price between “bid” and “ask” price is used for valuation purposes 354 and the parameters (σ and δ) are updated based on this valuation 356. If no “bid” and “ask” prices are available, the instrument is valued at its fair value, as calculated on the current parameters 355, before refreshing all parameters and proceeding to the next instrument in the update queue.

In summary, this invention provides for a structured database of financial instruments and a method and system, the deductive pricing method and system, that assure that the largest possible number of financial instruments in a portfolio are valued with prices that are accurate, timely and complete. Rather than limiting the valuation to “last trade”, as is customary today, the information contained in the structure of the financial instruments is exploited to infer valuations whenever market data are not available or not reliable. Furthermore, contrary to current practice, the methods used to infer fair value estimates for non-traded instruments employ, to the maximum extent possible, current market data, rather than historic data, to estimate the unknown parameters. This assures that the greatest number of financial instruments possible are valued at all times, consistent with all available market information, and that a complete picture of a portfolio and its risk characteristics is possible. In this manner, the essence of the principle that portfolios are to be “marked to market” is preserved.

While the invention has been described with reference to the preferred embodiment thereof, it will be appreciated by those of ordinary skill in the art that modifications can be made to the structure and elements of the invention without departing from the spirit and scope of the invention as a whole.

We claim:

1. A method of calculating the fair value of a portfolio of financial instruments including zero class instruments, simple instruments, aggregate instruments, derived instruments and composite instruments comprising the steps of:
a. automatically updating said financial instruments with market data whenever new financial data becomes available;
b. calculating the fair values for all derived financial instruments;
c. using said fair values as proxies for market prices for all financial instruments for which current market value is unavailable; and
d. calculating risk parameters for derived and composite instruments,
wherein said values derived in steps a-d above are used to calculate the value of said portfolio.

2. The method of claim 1 of calculating the fair value of a portfolio of financial instruments including zero class instruments, simple instruments, aggregate instruments, derived instruments and composite instruments comprising the additional steps of:
e. recording the price of a derived financial instrument;
f. recording the price of the underlying financial instrument if the last trade is within a fix period of time of the related derived financial instrument trade;
g. calculating the implied volatility of the value of the derived financial instrument; and,
h. using the implied volatility to calculate the fair value of the derived financial instrument until the next observed trade in said derived financial instrument,
wherein the fair market value of said derived financial instrument may be calculated relatively accurately between trades of said derived financial instrument.

3. The method of claim 2 wherein said derived financial instrument comprises an option.

4. The method of claim 1 of calculating the fair value of a portfolio of financial instruments including zero class instruments, simple instruments, aggregate instruments, derived instruments and composite instruments comprising the steps of:
i. recording the price of a derived financial instrument;
j. determining the yield of said derived financial instrument from common market data;
k. determining the zero risk value of related government securities from current market data;
l. determining the rating of said derived financial instruments from rating services;
m. determining the derived financial instrument spread specific to said derived financial instrument; and,
n. using said specific derived financial instrument spread to calculate the fair value of said derived financial instrument between trades in said derived financial instrument,
wherein the fair market value of said derived financial instrument may be calculated relatively accurately between trades of said derived financial instrument.

5. The method of claim 4 wherein said derived financial instrument comprises a bond.
